(19) United States
(12) Patent Application Publication
(10) Pub. No.: US 2022/0341207 A1
(43) Pub. Date: Oct. 27, 2022

(54) Portable Hunting Structure

(71) Applicant: Jeremy Caume, Trenton (CA)

(72) Inventor: Jeremy Caume, Trenton (CA)

(21) Appl. No.: 17/235,991

(22) Filed: Apr. 21, 2021

(51) Int. Cl. E04H 15/46; E04H 15/00; A01M 31/02

(52) U.S. Cl. CPC E04H 15/46; E04H 15/001; A01M 31/025

(57) ABSTRACT

A portable awning assembly comprises an awning frame including a pair of legs and a roof. The portable awning assembly is preferably used as a blind, shelter, awning, etc. for providing cover to a hunter and is easily portable so that the hunter is able to carry the portable awning assembly to different locations. The portable awning assembly includes collapsible, foldable and adjustable features to aid in portability thereof. The pair of legs are selectively retractable and extendable; and the roof is foldable and collapsible relative to the pair of legs such that the awning frame can be collapsed to at least half it's in use size.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of portable structures of existing art and more specifically relates to a portable hunting structure.

### RELATED ART

Hunters engaged in hunting of various animals often stand or sit outdoors in a relatively remote location. Hunters frequently use hunting blinds or shelters to cover themselves to reduce the chance of detection by prey and/or to seek shelter. Some blinds, such as natural ground blinds, may be simply created from grass, bushes, etc., and others may be more substantial or permanent structures. However, there are problems with these current blinds and shelters. For example, natural blinds generally do not substantially cover the hunter, and therefore the hunter is exposed to the elements; permanent blinds may not be permitted, and substantial but mobile blinds are often cumbersome and a burden to move, particularly as hunters are already burdened by carrying a gun, ammunition and other supplies for the day. Thus, a suitable solution is desired.

### SUMMARY OF THE INVENTION

In view of the foregoing disadvantages inherent in the known portable structure art, the present disclosure provides a novel portable hunting structure. The general purpose of the present disclosure, which will be described subsequently in greater detail, is to provide an easily transportable awning/blind/shelter that is lightweight and able to be folded into a smaller configuration for transportation and unfolded into a larger configuration for use.

A portable awning assembly is disclosed herein. The portable awning assembly includes an awning frame including a pair of legs and a roof. The pair of legs may be configured for supporting the awning frame vertically on a ground-surface. The pair of legs may include a first leg and a second leg. The first leg may include a first top-end, a first bottom-end opposite the first top-end and relative to the ground-surface in use, and a first length therebetween. The second leg may include a second top-end, a second bottom-end opposite the second top-end and relative to the ground-surface in said use, and a second length therebetween. The first length and the second length may be selectively moveable between a retracted position and at least two extended positions.

The roof may be pivotally attached to the pair of legs atop the first top-end and the second top-end. The roof may be pivotable about a horizontal axis relative to the pair of legs such that the roof is selectively movable between a collapsed position and at least two erect-positions. The roof may be defined by a first roof half and a second roof half. The first roof half and the second roof half may be hingedly attached together such that the roof is further movable between a folded position and an unfolded position.

According to another embodiment, a method of use for a portable awning assembly is also disclosed herein. The method of use includes providing the portable awning as above; placing the pair of legs on the ground-surface; moving the roof from the folded position to the unfolded position; extending the first length and the second length to a desired extended position; moving the roof relative to the pair of legs to a desired erect position; and attaching at least one of a roof mat to the roof and a rear mat to the rear of the awning frame.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable hunting structure, constructed and operative according to the teachings of the present disclosure.

FIG. 1 is a perspective view of a portable awning assembly during an ‘in-use’ condition, illustrating a rear mat and a roof mat attached to the portable awning assembly for providing cover, according to an embodiment of the disclosure.

FIG. 2 is a rear perspective view of the portable awning assembly according to an embodiment of the present disclosure.

FIG. 3A is a side view of the portable awning assembly, illustrating a roof in a first erect-position, according to an embodiment of the present disclosure.

FIG. 3B is a side view of the portable awning assembly, illustrating the roof in a second erect-position, according to an embodiment of the present disclosure.

FIG. 3C is a side view of the portable awning assembly, illustrating the roof in a third erect-position, according to an embodiment of the present disclosure.

FIG. 4A is a side view of the portable awning assembly, illustrating the roof in a collapsed position, according to an embodiment of the present disclosure.

FIG. 4B is a front view of the portable awning assembly of FIG. 4A, illustrating the roof in the collapsed position and an unfolded position, according to an embodiment of the present disclosure.

FIG. 5 is a rear perspective view of the portable awning assembly of FIG. 4B, illustrating the roof being moved to a folded position, according to an embodiment of the present disclosure.

FIG. 6 is a side view of the portable awning assembly, illustrating the roof in the folded position (and the portable awning assembly being in a fully collapsed position), according to an embodiment of the present disclosure.

FIG. 7A is a front view of the portable awning assembly, illustrating a pair of legs in a retracted position, according to an embodiment of the present disclosure.

FIG. 7B is a front view of the portable awning assembly, illustrating the pair of legs in a first extended-position, according to an embodiment of the present disclosure.

FIG. 7C is a front view of the portable awning assembly, illustrating the pair of legs in a second extended-position, according to an embodiment of the present disclosure.

FIG. 7D is a front view of the portable awning assembly, illustrating the pair of legs in a third extended-position, according to an embodiment of the present disclosure.

FIG. 8 is a flow diagram illustrating a method of use for a portable awning assembly, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a portable structure and more particularly to a portable hunting structure used to provide an easily transportable awning, shelter, blind, etc. particularly for use by hunters. Generally disclosed is a collapsible awning that may be carried into fields, marsh, woods, etc. The collapsible awning may be collapsed in half and may include a multi-positional roof, adjustable legs and hangers for hunting gear. In use, a roof of the collapsible awning may be unfolded, and a brace for the roof may be attached. The roof may be placed at a desired angle using the brace. Legs may be extended from the collapsible awning by removing pins from the legs and extending the legs to a desired height. Once the desired height is established, the pins may be placed back into the legs to hold them at the desired height. Grass or brush may be added to the roof and to a rear of the collapsible awning to provide cover. In some embodiments, the grass or brush may be provided on attachable mats.

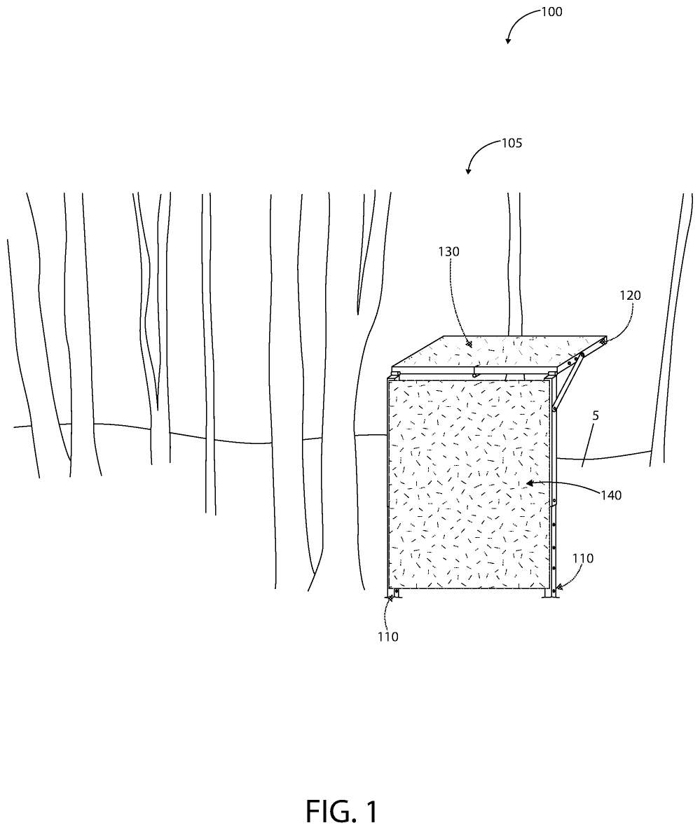

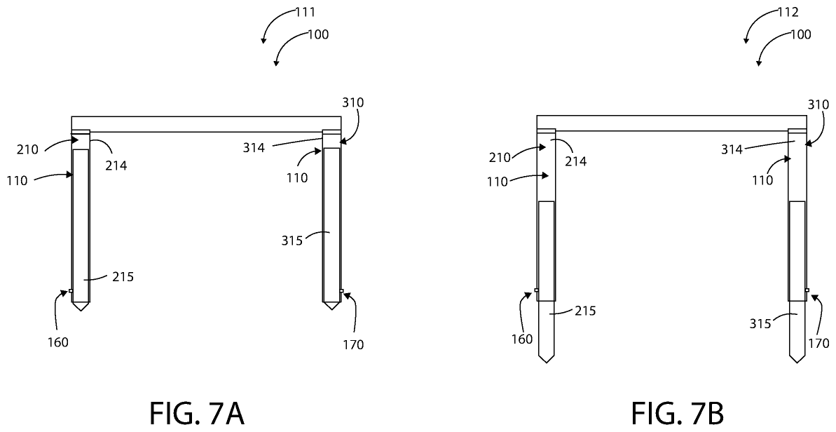

Referring now more specifically to the drawings by numerals of reference, there is shown in FIGS. 1-7D, various views of a portable awning assembly 100.

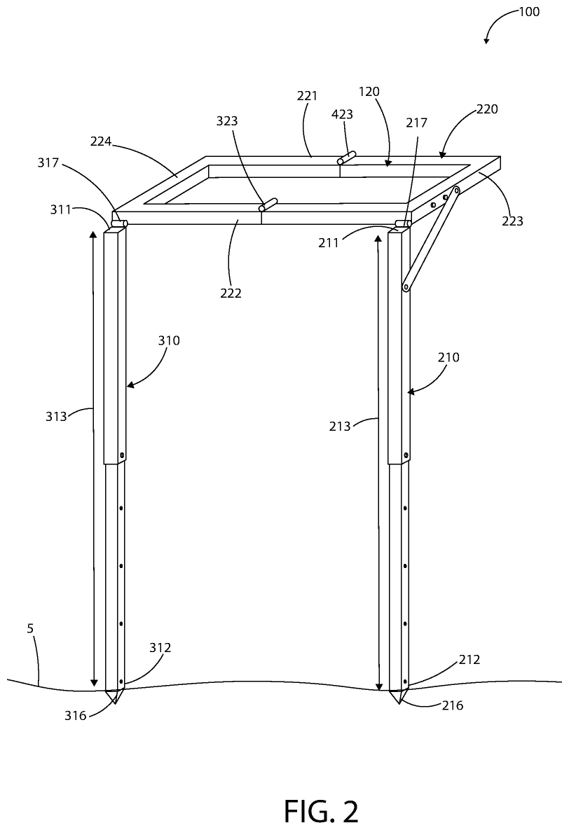

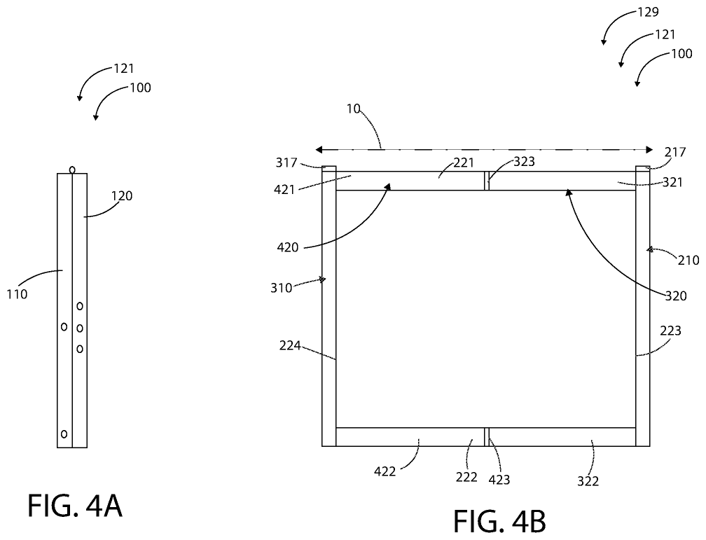

FIG. 1 shows a portable awning assembly 100 during an ‘in-use’ condition, according to an embodiment of the present disclosure. The portable awning assembly 100 may include an awning frame 105 which may include a pair of legs 110 and a roof 120. As shown in FIG. 1, the portable awning assembly 100 may be used as a hunting blind. As such, in some embodiments, the portable awning assembly 100 may further include a roof mat 130 for attachment to the roof 120 (the roof 120 being in an unfolded position 129), and a rear mat 140 for attachment to a rear of the awning frame 105. The roof mat 130 and the rear mat 140 may preferably include grass, brush, or some other kind of camouflage material for camouflaging the awning frame 105. In some embodiments, the roof mat 130 and the rear mat 140 may be provided with the portable awning assembly 100. In other embodiments, the roof mat 130 and the rear mat 140 may be separate from the portable awning assembly 100 and the awning frame 105 may be configured to accept standard mats. The mats (130, 140) may be removable from the portable awning assembly 100. As shown in FIGS. 2 and 4B specifically, the roof 120 may include a roof frame 220 having a front side 221 opposite a rear side 222 and a left side 223 opposite a right side 224 all relative to the ground-surface 5 (FIG. 2). The roof frame 220 may frame the roof mat 130 when the roof mat 130 is attached thereto.

As shown in FIG. 2, the pair of legs 110 may be configured for supporting the awning frame 105 vertically on the ground-surface 5. As above and as shown, the ground-surface 5 may be grass, soil, dirt, sand, etc. as the awning frame 105 may be used as a hunting blind. The pair of legs 110 may include a first leg 210 and a second leg 310. The first leg 210 may have a first top-end 211, a first bottom-end 212 opposite the first top-end 211 (and relative to the ground-surface 5 in use), and a first length 213 therebetween. The second leg 310 may have a second top-end 311, a second bottom-end 312 opposite the second top-end 311 (again, and relative to the ground-surface 5 in use), and a second length 313 therebetween. As shown in FIG. 2, preferably the first bottom-end 212 may include a first ground-piercing spike 216, and the second bottom-end 312 may include a second ground-piercing spike 316. The ground-piercing spikes (216, 316) may be useful wherein the portable awning assembly 100 is used in a soft unlevel surface.

Further, as shown in FIG. 2, the roof 120 may be pivotally attached to the pair of legs 110 atop the first top-end 211 and the second top-end 311. In some embodiments, the roof 120 and the top-ends (211, 311) of the pair of legs 110 may be connected via a first hinge 217 and a second hinge 317. For example, the first hinge 217 and the second hinge 317 may include barrel hinges. Preferably, the roof 120 may be pivotable about a horizontal axis 10 relative to the pair of legs 110 such that the roof 120 is selectively movable between a collapsed position 121 and at least two erect-positions.

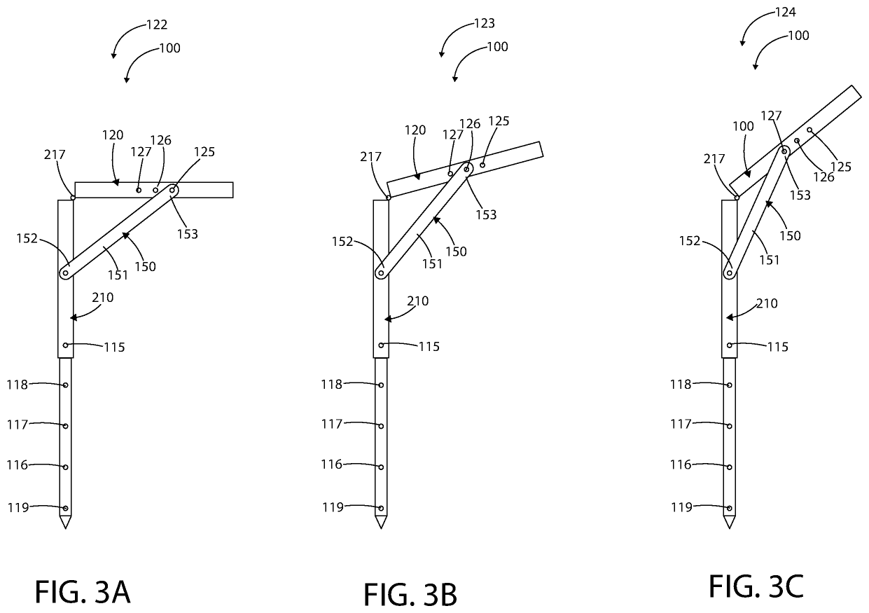

As shown in FIGS. 3A-3C, in some embodiments, the portable awning assembly 100 may further include at least one removable support-arm 150. As shown, the at least one removable support-arm 150 may be configured to support the roof 120 in the at least two erect-positions. The at least one removable support-arm 150 may be selectively attached to prop the roof 120 up or removed to collapse the roof 120. In some embodiments, the at least one removable support-arm 150 may include two removable support-arms (not illustrated). In this embodiment, one of the support-arms may be attached about one side of the roof 120 and one of the pair of legs 110, and another one of the support-arms may be attached about another side of the roof 120 and another one of the pair of legs 110. FIGS. 2-3C illustrate the at least one removable support-arm 150 being attached to the first leg 210, however it should be appreciated that this is for exemplary purposes only and the at least one removable support-arm 150 may be attached to either one of the first leg 210 or the second leg 310.

As shown in FIGS. 3A-3C, in some embodiments, the at least two erect-positions may include three erect-positions. The three erect-positions may include a first erect-position 122, a second erect-position 123 and a third erect-position 124. The first erect-position 122 may include the roof 120 being erected at a first angle relative to the pair of legs 110; the second erect-position 123 may include the roof 120 being erected at a second angle relative to the pair of legs 110; and the third erect-position 124 may include the roof 120 being erected at a third angle relative to the pair of legs 110.

Further, the at least one removable support arm 150 may include a bar 151 having a first arm-end 152 opposite a second arm-end 153. One of the first arm-end 152 and the second arm-end 153 may be configured for attachment to one of the first leg 210 and the second leg 310, and another one of the first arm-end 152 and the second arm-end 153 may be configured for attachment to the roof 120. For example, the first arm-end 152 may be configured for attachment to either the first leg 210 or the second leg 310 (or in some embodiments there may be two support arms each including the first arm-end 152 and one of the first arm-ends may attach to the first leg 210 and another one of the first arm-ends may attach to the second leg 310); and the second arm-end 153 (or second arm-ends) may be configured for attachment the roof 120. In FIGS. 3A-3C, the first arm-end 152 is shown to be attached to the first leg 210 and the second arm-end 153 is attached to the roof 120, but again, it should be appreciated that this is for exemplary purposes only, and that the first arm-end 152 is not limited to attachment to the first leg 210, nor is the second arm-end 153 limited to attachment to the roof 120.

The roof 120 may include three attachment points configured to mate with another one of the first arm-end 152 and the second arm-end 153. The three attachment points may include a first attachment point 125, a second attachment point 126 and a third attachment point 127. As shown, attachment of another one of the first arm-end 152 and the second arm-end 153 to the first attachment point 125 may support the roof 120 at the first angle relative to the pair of legs 110. Attachment of another one of the first arm-end 152 and the second arm-end 153 to the second attachment point 126 may support the roof 120 at the second angle relative to the pair of legs 110. Attachment of another one of the first arm-end 152 and the second arm-end 153 may support the roof 120 at the third angle relative to the pair of legs 110. This may enable the user to angle the roof 120 based on use of the portable awning assembly 110, environment, etc. In some examples, the attachment points (125, 126, 127) may be roof-protrusions, and the second arm-end 153 may include a second arm-aperture for mating with the roof-protrusions. Further, at least one of the first leg 210 or the second leg 310 may include a leg-protrusion and the first arm-end 152 may include a first arm-aperture for mating with the leg-protrusion.

Further, shown in FIGS. 4B-6, the roof 120 may be defined by a first roof half 320 and a second roof half 420. The first roof half 320 and the second roof half 420 may be hingedly attached together such that the roof 120 may be movable between a folded position 128 and the unfolded position 129. For example, in some embodiments, the first roof half 320 may include the left side 223, a first front half 321 of the front side 221, and a first rear half 322 of the rear side 222 (the front side 221 and the rear side 222 being relative to the ground-surface 5 in use).

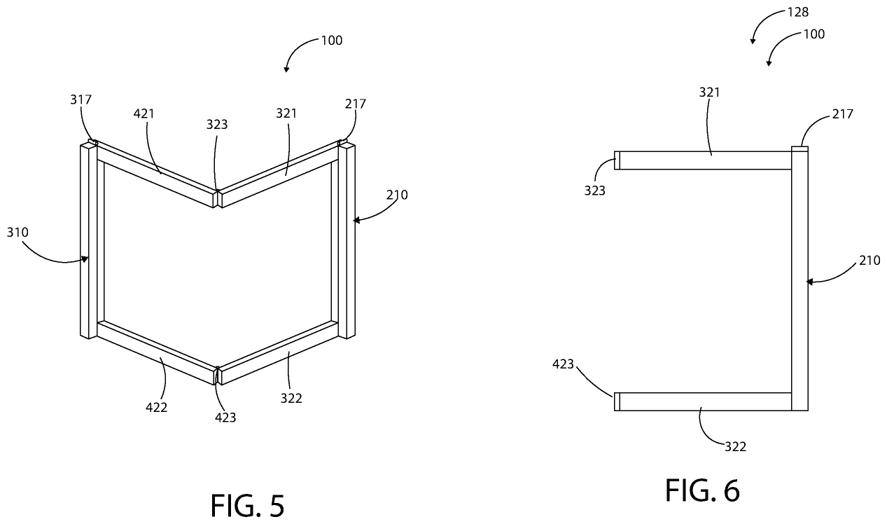

The second roof half 420 may include the right side 224, a second front half 421 of the front side 221 and a second rear half 422 of the rear side 222. In this embodiment, the first front half 321 and the second front half 421 may be hingedly connected and the first rear half 322 and the second rear half 322 may be hingedly connected. This may allow the user to fold the roof 120 in half. For example, in the unfolded position 129, the roof 120 may be 4-foot×4-foot. In the folded position 128, the roof 120 may be 4-foot×2-foot. In some embodiments, the first front half 321 and the second front half 421, and the first rear half 322 and the second rear half 422, may be connected via a third hinge 323 and a fourth hinge 423. The third hinge 323 and the fourth hinge 423 may be barrel hinges, as shown in FIG. 5. However, other means of connecting the halves (321, 421, 322, 422) are contemplated. Further, the roof 120 is not limited to this configuration. For example, in some embodiments, the left side 223 and the right side 224 may be hingedly-connected instead.

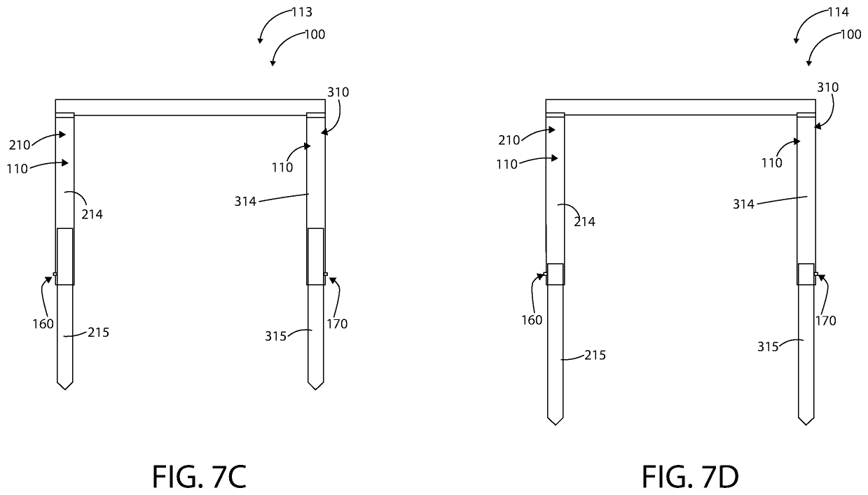

Preferably, a height of the awning frame 105 may be adjustable. As such, as shown in FIGS. 7A-7D, the first length 213 and the second length 313 may be selectively moveable between a retracted position 111 and at least two extended positions. The retracted position 111 may include the pair of legs 110 having a height of 4 feet. As such, when the pair of legs 110 are in the retracted position 111 and the roof 120 is in the collapsed position 121, the pair of legs 110 and the left side 223 and the right side 224 of the roof 120 may be equal in height. At their highest extended position, the pair of legs 110 may include a height of 8 feet.

In some embodiments, the at least two extended-positions may include at least three extended-positions. The at least three extended-positions may include a first extended-position 112, a second extended-position 113, and a third extended-position 114 (and in some embodiments, a fourth extended-position, a fifth extended-position etc.). The first extended-position 112 may include the pair of legs 110 extended at a first height, the second extended-position 113 may include the pair of legs 110 extended at a second height, and the third extended-position 114 may include the pair of legs 110 extended at a third height.

Preferably, to facilitate the extension, the first length 213 and the second length 313 of the pair of legs 110 may be telescopic. As such, in this embodiment, the first length 213 may include a first main shaft 214 and a first telescoping shaft 215, and the second length 313 may include a second main shaft 314 and a second telescoping shaft 315. In FIGS. 7A-7D, the pair of legs 110 are shown to be transparent for illustrative purposes to enable a view of the first telescoping shaft 215 within the first main shaft 214 and the second telescoping shaft 315 within the second main shaft 314.

Further, the portable awning assembly 100 may include a pair of pins including a first pin 160 and a second pin 170. The first main shaft 214 and the second main shaft 314 may each include a main aperture 115 and the first telescoping shaft 215 and the second telescoping shaft 315 may each include at least four telescoping apertures, as illustrated in FIGS. 3A-3C. The at least four telescoping apertures may include a first telescoping aperture 116, a second telescoping aperture 117, a third telescoping aperture 118, and a fourth telescoping aperture 119. Insertion of the first pin 160 and the second pin 170 into each main aperture 115 and first telescoping aperture 116 may lock the pair of legs 110 at the first height. Insertion of the first pin 160 and the second pin 170 into each main aperture 115 and second telescoping aperture 117 may lock the pair of legs 110 at the second height. Insertion of the first pin 160 and the second pin 170 into each main aperture 115 and third telescoping aperture 118 may lock the pair of legs 110 at the third height. Insertion of the first pin 160 and the second pin 170 into each main aperture 115 may lock the pair of legs 110 in the retracted position 111 (as shown in FIG. 7A). It should be appreciated that this described pin lock system is given as an exemplary embodiment and the portable awning assembly 100 is not limited to this, nor are the pair of legs 110 limited to being adjustable via telescoping means.

The portable awning assembly 100 may include the above described foldable, collapsible and adjustable features to aid in portability thereof. To add to this portability, the portable awning assembly 100 may further comprise a strap (not illustrated) attached to the awning frame 105. Further, in some embodiments, the portable awning assembly 100 may include hanging means such as hooks (not illustrated) attached to the awning frame. The hanging means may be configured for holding hunting gear and accessories.

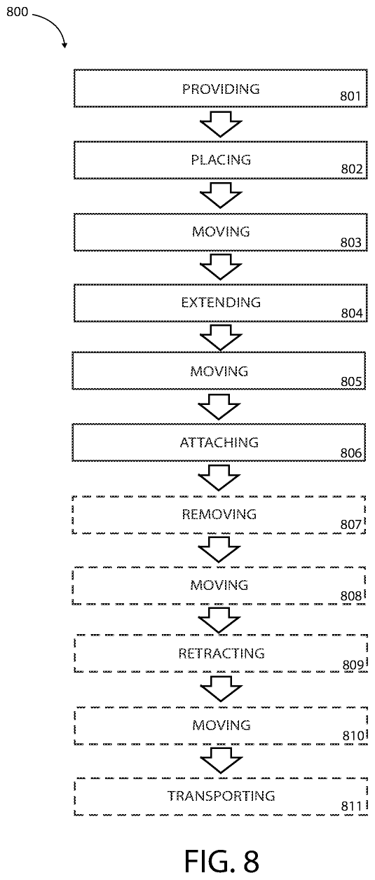

Referring now to FIG. 8 showing a flow diagram illustrating a method of use 800 for a portable awning assembly, according to an embodiment of the present disclosure. In particular, the method of use 800 may include one or more components or features of the portable awning assembly 100 as described above. As illustrated, the method of use 800 may include the steps of: step one 801, providing the portable awning assembly as above; step two 802, placing the pair of legs on the ground-surface; step three 803, moving the roof from the folded position to the unfolded position; step four 804, extending the first length and the second length to a desired extended position; step five 805, moving the roof relative to the pair of legs to a desired erect position; and step six 806, attaching at least one of the roof mat to the roof and the rear mat to the rear of the awning frame.

Further steps may include, particularly, steps of collapsing the portable awning assembly 100. As illustrated, these steps may include step seven 807, removing said at least one of the roof mat from the roof and the rear mat from the rear of the awning frame; step eight 808, moving the roof relative to the pair of legs to the collapsed position; step nine 809, retracting the first length and the second length to a retracted position; step ten 810, moving the roof from the unfolded position to the folded position; and step eleven 811, transporting the portable awning assembly.

It should be noted that step seven 807, eight 808, nine, 809, ten, 810 and eleven 811 are optional steps and may not be implemented in all cases. Optional steps of method of use 800 are illustrated using dotted lines in FIG. 8 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a portable hunting awning assembly are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable awning assembly comprising:
an awning frame including:
a pair of legs configured for supporting the awning frame vertically on a ground-surface, the pair of legs including a first leg and a second leg, the first leg having a first top-end, a first bottom-end opposite the first top-end and relative to the ground-surface in use, and a first length therebetween, the second leg including a second top-end, a second bottom-end opposite the second top-end and relative to the ground surface in said use, and a second length therebetween, the first length and the second length being selectively moveable between a retracted position and at least two extended positions; and
a roof pivotally attached to the pair of legs atop the first top-end and the second top-end, the roof being pivotable about a horizontal axis relative to the pair of legs such that the roof is selectively movable between a collapsed position and at least two erect-positions, the roof being defined by a first roof half and a second roof half, the first roof half and the second roof half being hingedly attached together such that the roof is further movable between a folded position and an unfolded position.

2. The portable awning assembly of claim 1, further comprising a roof mat for attachment to the roof in the unfolded position.

3. The portable awning assembly of claim 2, further comprising a rear mat for attachment to a rear of the awning frame.

4. The portable awning assembly of claim 1, further comprising at least one removable support-arm configured to support the roof in the at least two erect-positions.

5. The portable awning assembly of claim 4, wherein the at least two erect-positions includes three erect-positions, wherein the three erect-positions includes a first erect-position, a second erect-position and a third erect-position, wherein the first erect-position includes the roof erected at a first angle relative to the pair of legs, wherein the second erect-position includes the roof erected at a second angle relative to the pair of legs, and wherein the third erect-position includes the roof erected at a third angle relative to the pair of legs.

6. The portable awning assembly of claim 5, wherein the at least one support arm includes a bar having a first arm-end opposite a second arm-end, wherein one of the first arm-end and the second arm-end is configured for attachment to one of the first leg and the second leg, and wherein another one of the first arm-end and the second arm-end is configured for attachment to the roof.

7. The portable awning assembly of claim 6, wherein the roof includes three attachment points configured to mate with said another one of the first arm-end and the second arm-end, wherein the three attachment points includes a first attachment point, a second attachment point and a third attachment point.

8. The portable awning assembly of claim 7, wherein attachment of said another one of the first arm-end and the second arm-end to the first attachment point supports the roof at the first angle relative to the pair of legs, wherein attachment of said another one of the first arm-end and the second arm-end to the second attachment point supports the roof at the second angle relative to the pair of legs, and wherein attachment of said another one of the first arm-end and the second arm-end supports the roof at the third angle relative to the pair of legs.

9. The portable awning assembly of claim 8, wherein the roof includes a roof frame having a front side opposite a rear side and a left side opposite a right side all relative to the ground surface.

10. The portable awning assembly of claim 9, wherein the first roof half includes the left side, a first front half of the front side and a first rear half of the rear side, wherein the second roof half includes the right side, a second front half of the front side and a second rear half of the rear side, wherein the first front half and the second front half are hingedly connected, and wherein the first rear half and the second rear half are also hingedly connected.

11. The portable awning assembly of claim 1, wherein the at least two extended-positions includes at least three extended-positions, wherein the at least three extended-positions includes a first extended-position, a second extended-position, and a third extended-position, wherein the first extended-position includes the pair of legs extended at a first height, wherein the second extended-position includes the pair of legs extended at a second height, and wherein the third extended-position includes the pair of legs extended at a third height.

12. The portable awning assembly of claim 11, wherein the first length and the second length of the pair of legs are telescopic, wherein the first length includes a first main shaft and a first telescoping shaft, and wherein the second length includes a second main shaft and a second telescoping shaft.

13. The portable awning assembly of claim 12, further comprising a pair of pins, the pair of pins including a first pin and a second pin.

14. The portable awning assembly of claim 13, wherein the first main shaft and the second main shaft each include a main aperture, wherein the first telescoping shaft and the second telescoping shaft each include at least four telescoping apertures, wherein the at least four telescoping apertures includes a first telescoping aperture, a second telescoping aperture, a third telescoping aperture, and fourth telescoping aperture, wherein insertion of the first pin and the second pin into each main aperture and first telescoping aperture locks the pair of legs at the first height, wherein insertion of the first pin and the second pin into each main aperture and second telescoping aperture locks of the pair of legs at the second height, wherein insertion of the first pin and the second pin into each main aperture and third telescoping aperture locks the pair of legs at the third height, and wherein insertion of the first pin and the second pin into each main aperture and fourth telescoping aperture locks the pair of legs in the retracted position.

15. The portable awning assembly of claim 14, wherein the first bottom-end includes a first ground-piercing spike, and wherein the second bottom-end includes a second ground-piercing spike.

16. A portable awning assembly comprising:
an awning frame including:
a pair of legs configured for supporting the awning frame vertically on a ground-surface, the pair of legs including a first leg and a second leg, the first leg having a first top-end, a first bottom-end opposite the first top-end and relative to the ground-surface, and a first length therebetween, the second leg including a second top-end, a second bottom-end opposite the second top-end and relative to the ground surface, and a second length therebetween, the first bottom-end including a first ground-piercing spike, the second bottom-end including a second ground-piercing spike. the first length and the second length of the pair of legs being telescopic and movable between a retracted position and at least three extended positions;
a roof pivotally attached to the pair of legs atop the first top-end and the second top-end, the roof being pivotable about a horizontal axis relative to the pair of legs such that the roof is selectively movable between a collapsed position and at least three erect-positions, the roof being defined by a first roof half and a second roof half, the first roof half and the second roof half being hingedly attached together such that the roof is further movable between a folded position and an unfolded position, the roof further including a roof frame having a front side opposite a rear side and a left side opposite a right side all relative to the ground surface, the first roof half including the left side, a first front half of the front side and a first rear half of the rear side, wherein the second roof half includes the right side, a second front half of the front side and a second rear half of the rear side, wherein the first front half and the second front half are also hingedly connected, and wherein the first rear half and the second rear half are also hingedly connected; and
at least one removable support-arm configured to support the roof into the at least two erect-positions, the at least one support arm including a bar having a first arm-end opposite a second arm-end, wherein one of the first arm-end and the second arm-end is configured for attachment to one of the first leg and the second leg, and wherein another one of the first arm-end and the second arm-end is configured for attachment to the roof;
a strap attached to the awning frame; and
a pair of pins including a first pin and a second pin; and
wherein the three erect-positions includes a first erect-position, a second erect-position and a third erect-position, wherein the first erect-position includes the roof erected at a first angle relative to the pair of legs, wherein the second erect-position includes the roof erected at a second angle relative to the pair of legs, and wherein the third erect-position includes the roof erected at a third angle relative to the pair of legs;
wherein the roof includes three attachment points configured to mate with said another one of the first arm-end and the second arm-end, wherein the three attachment points includes a first attachment point, a second attachment point and a third attachment point;
wherein attachment of said another one of the first arm-end and the second arm-end to the first attachment point supports the roof at the first angle relative to the pair of legs, wherein attachment of said another one of the first arm-end and the second arm-end to the second attachment point supports the roof at the second angle relative to the pair of legs, and wherein attachment of said another one of the first arm-end and the second arm-end supports the roof at the third angle relative to the pair of legs;
wherein the first length includes a first main shaft and a first telescoping shaft, and wherein the second length includes a second main shaft and a second telescoping shaft; and
wherein the first main shaft and the second main shaft each include a main aperture, wherein the first telescoping shaft and the second telescoping shaft each include at least four telescoping apertures, wherein the at least four telescoping apertures includes a first telescoping aperture, a second telescoping aperture, a third telescoping aperture, and fourth telescoping aperture, wherein insertion of the first pin and the second pin into each main aperture and first telescoping aperture locks the pair of legs at the first height, wherein insertion of the first pin and the second pin into each main aperture and second telescoping aperture locks of the pair of legs at the second height, wherein insertion of the first pin and the second pin into each main aperture and third telescoping aperture locks the pair of legs at the third height, and wherein insertion of the first pin and the second pin into each main aperture and fourth telescoping aperture locks the pair of legs in the retracted position.

17. The portable awning assembly of claim 16, further comprising a roof mat for attachment to the roof in the unfolded position.

18. The portable awning assembly of claim 17, further comprising a rear mat for attachment to a rear of the awning frame.

19. A method of use for a portable awning assembly, the method comprising the steps of:
providing the portable awning assembly including:
an awning frame including:
a pair of legs configured for supporting the awning frame vertically on a ground-surface, the pair of legs including a first leg and a second leg, the first leg having a first top-end, a first bottom-end opposite the first top-end and relative to the ground-surface, and a first length therebetween, the second leg including a second top-end, a second bottom-end opposite the second top-end and relative to the ground surface, and a second length therebetween, the first length and the second length being selectively moveable between a retracted position and at least two extended positions; and
a roof pivotally attached to the pair of legs atop the first top-end and the second top-end, the roof being pivotable about a horizontal axis relative to the pair of legs such that the roof is selectively movable between a collapsed position and at least two erect-positions, the roof being defined by a first roof half and a second roof half, the first roof half and the second roof half being hingedly attached together such that the roof is further movable between a folded position and an unfolded position;
a roof mat for attachment to the roof in the unfolded position; and
a rear mat for attachment to a rear of the awning frame;
placing the pair of legs on the ground-surface;
moving the roof from the folded position to the unfolded position;
extending the first length and the second length to a desired extended position;
moving the roof relative to the pair of legs to a desired erect position; and
attaching at least one of the roof mat to the roof and the rear mat to the rear of the awning frame.

20. The method of claim 19, further comprising the steps of:
removing said at least one of the roof mat from the roof and the rear mat from the rear of the awning frame;
moving the roof relative to the pair of legs to the collapsed position;
retracting the first length and the second length to a retracted position;
moving the roof from the unfolded position to the folded position; and
transporting the portable awning assembly.
